(19) United States
(12) Patent Application Publication
(10) Pub. No.: US 2016/0224561 A1
(43) Pub. Date: Aug. 4, 2016

(54) CONTENT PROVISION BASED ON USER-PAIR AFFINITY IN A SOCIAL NETWORK

(71) Applicant: Linkedln Corporation, Mountain View, CA (US)

(72) Inventors: Deepak Agarwal, Sunnyvale, CA (US); Qi He, San Jose, CA (US); Jaewon Yang, Sunnyvale, CA (US); Bee-Chung Chen, San Jose, CA (US)

(21) Appl. No.: 14/788,260

(22) Filed: Jun. 30, 2015

Related U.S. Application Data
(60) Provisional application No. 62/110,306, filed on Jan. 30, 2015.

(51) Int. Cl. G06F 17/30

(52) U.S. Cl. CPC G06F 17/3053; G06F 17/30867; G06F 17/30554

(57) ABSTRACT

A system and method for content provision based on user-affinity in a social network includes generating a people affinity score representing a measure of affinity between a member of a social networking service and a user that is related to a content item, having a content item type, hosted by the social networking service. A type context score is generated based on activities by the member, obtained from an activity database, with content items of the content item type previously hosted by the social networking service. A likelihood score, representing a likelihood of the member interacting with the content item, is determined by applying to the type context score and the people affinity score with a mathematical operation. A user interface associated with the member displays the content item based, at least in part, on the likelihood score.

### CROSS-REFERENCE TO RELATED APPLICATIONS

This application claims the benefit of U.S. Provisional Application No. 62/110,306, filed Jan. 30, 2015, entitled “CONTENT PROVISION BASED ON ENTITY-PAIR AFFINITY IN A SOCIAL NETWORK,” which is incorporated herein by reference in its entirety.

### TECHNICAL FIELD

The subject matter disclosed herein generally relates to the presentation of content in a social networking service or system based on an affinity two users have for shared content.

### BACKGROUND

Social network services or systems conventionally allow for members, acting on their own behalf or that of a larger organization, to post content to the social network to be viewed by members of the social network. Members may provide content items to the social network. The social network may cause those items to be displayed on user interfaces of various members of the social network based on a variety of criteria. For instance, members who are connected to one another may see content items the other has posted to the social network, while a member who follows a company or group may see the content items posted by that company or group.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network system 100, consistent with some examples.

FIG. 2 is a simplified illustration of a social network, in an example embodiment.

FIG. 3 is a depiction of a user interface as provided by the social network system, in an example embodiment.

FIG. 4 illustrates the determination of likelihood scores for multiple content items of a group of content items that is being considered for display on a user interface, in an example embodiment.

FIG. 5 is a flowchart for content provision based on user-affinity in a social network, in an example embodiment.

FIG. 6 is a block diagram illustrating components of a machine, according to some example embodiments.

### DETAILED DESCRIPTION

Example methods and systems are directed to the presentation of content in a social network based on an affinity for content between two users. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Conventionally, content items for a social network may be displayed on a user interface of a user device associated with a member or user entirely or substantially entirely because the content items were received by the social network and automatically displayed to all of the members who are connected to the user that provided the content item. The order in which content items are displayed may be as basic as the sequence in which they were received. Thus, a the user interface may simply be the display of some or all of the content items the member's connections posted to the social network in the order those content items were received.

Such a system may be insensitive to what the member would be most likely to find interesting and actually engage with by selecting a link, commenting, “liking”, sharing with other members of the social network, and so on. Further, as the social network becomes large and the number of users of the social network and the connections between users increases, members may be inundated with unwieldy amounts of content items. Simply presenting content items to members in chronological order or another basic and conventional scheme may create a reduced user experience and less engagement with the social network.

However, anticipating what content items a member will likely want to see and will likely engage with may not be straightforward. It has been determined that members have a tendency to engage more frequently or more readily with content items posted by particular users than with content items posted by other users. A system has been developed that identifies user pairs in the social network including a first user and a second user. The first user is a member of the social network to whom a content item posted to the social network by the second user may be displayed. The user pair is assigned a people affinity score that provides an adjustment to where on the user interface of a user device associated with the first member the content item is displayed.

As such, the system may be utilized to generate a likelihood score indicative of a likelihood that a content item will be interacted with by a member if the content item is displayed on a user interface presented to the member. The likelihood score may be separately calculated for multiple content items and utilized to rank the content items at least in part according to their relative likelihoods. The likelihood scores may be combined with other factors, such as values of the individual content items, or may be utilized without respect to other factors. The likelihood scores is based on an affinity the member has for the content item type as well as an affinity the member has for the user who provided the content item to the social networking system.

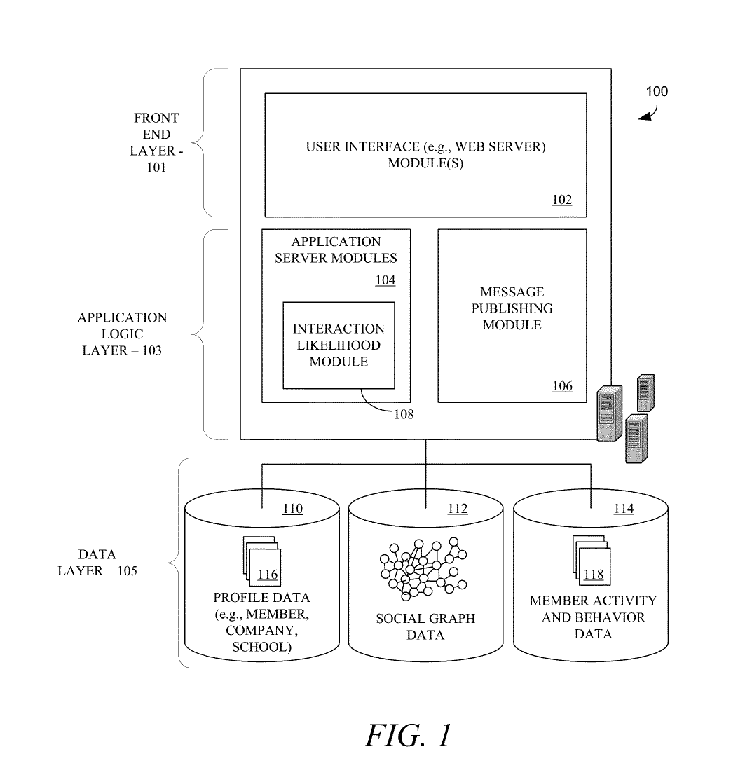

FIG. 1 is a block diagram illustrating various components or functional modules of a social network system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include a interaction likelihood module 108. As will be disclosed in detail herein, the interaction likelihood module 108 may determine a relatively likelihood that a member of a social network will interact with a given content item displayed on their user interface. The interaction likelihood module 108 may make the determination based on an affinity between the member to whom the content item may be displayed and a user that provided the content item or is the subject of the content item, as well as a context of the content item. The interaction likelihood module 108 may utilize member profiles, social graph, and user activities in the determination of interaction likelihood.

The interaction likelihood module 108 may be implemented on a separate server or may be part of a server that provides other portions of the social network system 100. Thus, it is to be understood that while the interaction likelihood module 108 is described as an integral component of a social network, the principles described herein may be applied without the interaction likelihood module 108 being an integral part of a social network or even necessarily utilizing data from a social network if member profile information, social graph information, and user activities are available from alternative sources.

As illustrated, the data layer 105 includes, but is not necessarily limited to, several databases 110, 112, 114, such as a database 110 for storing profile data 116, including both member profile data as well as profile data for various organizations (e.g., schools, businesses, and so on). Member profile data may include a list of connections each member has with other members of the social network. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may utilize a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other users and objects, are stored and maintained within the social graph database 112.

Activities by users of the social network system 100 may be logged as activities 118 in the activity and behavior database 114. Such activities 118 may include interactions with content displayed on the social network. Interactions may include clicking on a link to read an article, commenting on a post to the social network, “liking” or otherwise approving of a post, sharing the post, or any of a variety of mechanisms by which a member may engage with social network content.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

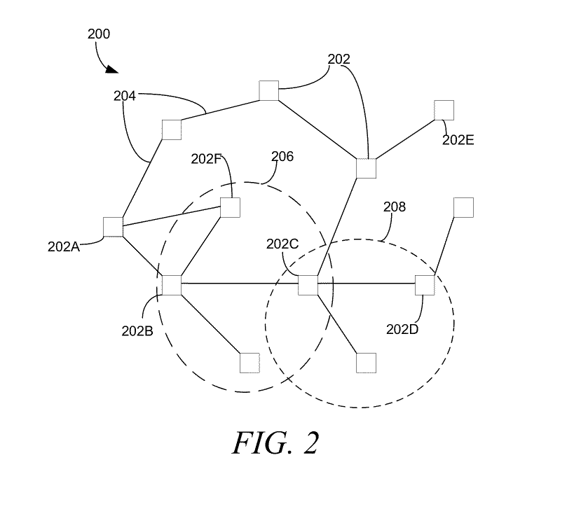

FIG. 2 is a simplified illustration of a social network 200, in an example embodiment. The social network 200 may be provided by the social network system 100 or any suitable system.

The social network 200 includes users 202 linked to one another within the social network 200 via connections 204. A user 202 may be a member of the social network 200, a person acting on behalf of a company or organization that has access and may post content to the social network 200, or any person, organization, or system that may interact with or influence the social network 200. Not all users 202 have connections 204 with all of the other users 202. Certain users 202 have further affiliations with other users 202. For instance, certain users 202 are employees of the same company 206, as noted in those members' 202 profile data 116. Other users 202 are related to one another for having attended the same school 208.

Users 202 of the social network 200 have defined connection relationships between one another. Users 202A, 202B who have a direct connection 204 have a first-degree connection. Users 202A, 202C who do not have a direct connection 204 with one another but who each have a direct connection 204 to another user 202B have a second-degree connection. Users 202A, 202D who do not have a second-degree connection but who are connected via two other users 202B, 202C have a third-degree connection, and so forth.

The illustration of the social network 200 is simplified for the purposes of explanation. It is to be understood that the social network 200 may incorporate millions or billions of users 202. Each of those users 202 may have dozens or hundreds of affiliations or more that may be formally chosen by each user 202, such as groups that the user 202 may elect to join, or may be inferred by the social network 200 from the member's 202 profile data 116.

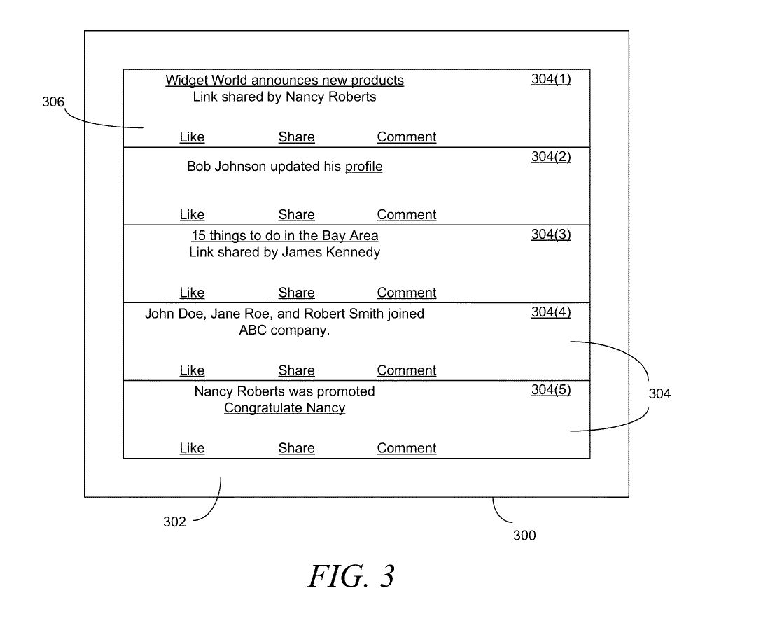

FIG. 3 is a depiction of a user interface 300 as provided by the social network system 100, in an example embodiment. The user interface 300 includes a feed 302 that includes multiple individual positions 304 arranged, in this example, in a vertical list with a first position 304(1) at the top and lower positions 304 sequentially down the list. Each position 304 includes space to display content related to the content item 306; in various examples, the content item 306 itself may be displayed, for instance if the content item 306 is a link or a renderable image, or data relating to the content item 306 may be displayed, such as if the content item 306 needs to be reformatted for the user interface 300 or the circumstances in which the user interface 300 is being displayed. The positions 304 further include various user interface elements (e.g., buttons, links, etc) providing what are sometimes referred to as social gestures to interact with the content item 306, including a link to “like” the content item 306, share the content item 306 on the social network 200, and comment on the content item 306. It is to be recognized that the user interface 300 is provided for the purposes of an example and that many additional configurations of user interfaces 300 are contemplated and may be utilized consistent with the principles described herein.

Each content item 306 has an identifiable content item type. The content item type may be a general identifier and not necessarily specific to the particular content of the content item 306. Thus, for instance, a content item type may be a link provided by a specific user 202 (e.g., the content items 306 in the first position 304(1) provided by “Nancy Roberts” and in the third position 304(3) provided by “James Kennedy”), a content item 306 may be a profile update notification with the subject being a certain user 202 but automatically generated by the social network system 100 (e.g., the content item 306 in the second position 304(2)), a change of status notification of a user 202 generated by the social network system 100 (e.g., the content items 306 in the fourth position 304(4) and 304(5)), and so forth. The content item types provided herein are for illustration and example only and it is to be recognized that any of a variety of content item types may be utilized by the social network system 100.

The content item types provided herein are illustrative of particular content item types that may be utilized in certain specific examples. However, content item types may be organized based, at least in part, on a source of the content item 306, e.g., a particular user 202, and an actor of the content item 306, e.g., a user 202 or other potential actor that engaged in the activity described in the content item 306. For instance, “Bob Johnson updated his profile” would have as an actor “Bob Johnson” and, depending on what exactly generated the content item 306, either Bob Johnson or, for instance, the message publishing module 106. A content item type for a content item 306 may be a junction of the two variables involving the content item 306, the actor and the source. Thus, in an example, a content item type for the above content item 306 would be (“Bob Johnson”; “Bob Johnson”). Conventionally, the phrase “Bob Johnson liked John Doe's profile update” would have a content item type of (“Bob Johnson”; “John Doe”).

The content item type may be scaled to any of a number of different variables and sources of those variables. Thus, the above example may further include a verb of the content item 306 as a content item type variable, and thus the content item type for the above content item 306 could be (“Bob Johnson”; “Bob Johnson”; profile update), in an example embodiment. By way of further example, an object type may be the “profile”, resulting in a content item type of (“Bob Johnson”; “Bob Johnson”; profile update; profile).

The specific content item types may be based on the type or goal of the social network 200. Thus, a social network 200 that is oriented around professional development may specifically differentiate a change in company (e.g., as illustrated in the fourth position 304(4)) and a change in job title or position (e.g., as illustrated in the fifth position 304(5)) as separate content item types. By contrast, a social network that is oriented around non-professional interaction may utilize different content item types and groupings of particular content items into content item types as appropriate to that social network 200.

The interaction likelihood module 108 may be utilized by the social network system 100 to generate a likelihood score indicative of a likelihood that a content item 306 will be interacted with by a member 202 if the content item 306 is displayed on a user interface 300 presented to the member. As will be disclosed in detail herein, a likelihood score may be separately calculated for multiple content items 306 and utilized to rank the content items 306 at least in part according to their relative likelihoods. The likelihood scores may be combined with other factors, such as values of the individual content items 306, or may be utilized without respect to other factors.

The interaction likelihood module 108 may apply two factors in determining the likelihood score: a people affinity score and a type context score. The likelihood score may utilize additional factors as disclosed herein, including but not limited to a people affinity score in the context of a particular content item type and any of multiple additional profile and content item type details available in the social network generally. The people affinity score is a score that is based on an affinity between two discrete users 202 of the social network 200, one user 202 (e.g., the user 202B) that either provided or is the subject of the content item 306 for which the likelihood score is being determined and another member 202 (e.g., the user 202A) to whom the content its being considered for presentation or display. To determine the people affinity score, the interaction likelihood module 108 may utilize one or both of profile data 116 of the subject users 202A, 202B and social graph information from the social graph database 112. By contrast, the type context score is based, at least in part, on activities 118 performed by the target user 202A in relation to the content item type of the subject content item 306. Thus, the type context score is based, at least in part, on interactions by the user 202A with content items 306 of the same content item type as the subject content item 306. The determination of these scores will be described in detail herein.

As noted above, the people affinity score may be based on one or more of the profile data 116 of the users 202A, 202B and the social graph as it relates to those users 202A, 202B. In general, the people affinity score is agnostic concerning the nature of the subject content item 306 and focuses instead on indicators of overall quality of a relationship or potential relationship between the users 202A, 202B. While the people affinity score will be described based on an overall quality of a connection 204 between the users 202A, 202B and a similarity of the profile data 116 of the users 202A, 202B, it is to be recognized that any of a variety of factors that speak to a relationship or likely relationship between users 202 may be utilized.

The social graph score of the people affinity score may be based on a social graph density related to the users 202A, 202B. In particular, common connections 204 around the users 202A, 202B may suggest the degree of their social graph density. Connection degrees, as described above, may be assigned values and certain of those values may be combined to obtain a social graph density score. In an illustrative example, the first-degree connection between the users 202A, 202B may be assigned a point value of 4.0. Connections 204 to a user 202, e.g., user 202F, that provide a first-degree connection between the users 202A, 202B may be assigned a point value of 3.5. Connections 204 to a user 202, e.g., user 202C, that provide a first-degree connection to one of the users 202B and a second-degree connection to may be assigned a point value of 3.0. Connections 204 to a user 202 that provide second-degree connections to both of the users 202A, 202B, may be assigned a point value of 2.5, and so forth.

In an example, all of the connections 204 that receive point values in the manner described above may be combined together, for instance by being added together, to obtain the social graph density score. Alternatively, the point values may be multiplied, averaged, a maximum or minimum may be selected, and so forth. It is noted that the values provided are for example and that various social network systems 100 may utilize different values depending on the policies and goals of the associated social network 200. In particular, scored connections 204 may be limited or the values reduced if, for instance, a social network 200 is particularly large or if social graph density is not necessarily a favored policy of the social network 200. Further, it is to be recognized that the scored connections 204 may be expanded or the scores increased based on social network policy. Moreover, the values may be adjusted over time depending on empirical assessments of the performance of the interaction likelihood module 108; if the determined likelihoods are inaccurate then, as with some or all of the scores and values disclosed herein with respect to determining the likelihood score, the values and policies that underlie those values may be adjusted to generate appropriate likelihood scores.

The profile score of the people affinity score may be based on common or related profile data 116 between the users 202A, 202B. The profile data 116 may include particular data points as disclosed herein, such as, but not limited to, career, education, age, gender, location, interests, and so forth. To the extent that those data points are the same or similar between the users 202A, 202B, the profile score may be increased.

In an example, if the career profile data 116 for each of the users 202A, 202B indicate that each are electrical engineers then that profile data 116 may be worth 1.0 point. If the career profile data 116 is related by not the same a lesser point value may be given. Thus, if the user 202A is an electrical engineer and the user 202B is a software engineer then the career profile data 116 may be worth 0.8 points. The less relevant to one another the career profile data 116 are the lower the score may be. Thus, to complete the illustrative example, if the user 202B were an industrial engineer the career profile data 116 may be worth 0.5 points a technical writer may be 0.2 points while careers outside of engineering or the physical sciences may be worth 0.0 in relation to an electrical engineer.

These principles may be applied across the profile data 116 of the users 202A, 202B. The profile data 116 may map between users 202 not of the same type. Thus, for instance, if the user 202A is a member and the user 202B is a company then the career profile data 116 may be based on company profile data of common careers in the company or careers in which the company is hiring or expects to hire, among other profile data 116 that is potentially relevant to the career of the user 202A.

The values may be determined empirically by parsing the social graph database 112 to determine profile data 116 that tends to be in common between users 202 that interact with the content provided by or related to other users 202. Thus, if a statistical analysis indicates that electrical engineers are relatively likely to interact with content items provided by or about software engineers then the point value of the career data point 116 between an electrical engineer and a software engineer may be set relatively high, as in the example above. However, if the analysis of the interaction patterns between electrical and software engineers indicates that those two careers are becoming less likely to interact with content items provided by or about one another then the associated value may be decreased.

The values of the profile data 116 between the users 202A, 202B may be combined to produce the profile score. The combination of the values may be by addition, multiplication, mean, mode, or any of a variety of statistical or mathematical operations. The operation may be selected based on the policies of the social network 200 and/or empirical analysis of the most effective statistical or mathematical operation. Thus, it may be determined or chosen in a particular social network that relatively high profile scores produce the best results, in which case the values may be multiplied together or given a bonus or weight. In an example, the values are added.

The people affinity score may be determined based on the profile score and the social graph density score. As with the profile and the social graph density scores individually, the people affinity score may be determined based on any of a variety of statistical or mathematical operations, including addition, multiplication, mean, and so forth. In an example, the profile and social graph density scores are added to one another to determine the people affinity score.

As with the individual profile and social graph density scores, the mechanism for determining the people affinity score may be modified based on social network 200 policies and empirical analysis of the results using existing mechanisms. Thus, one or the other of the profile and social graph density scores may be weighted or otherwise adjusted to favor that factor. As a corollary, the people affinity score may optionally be based solely on one or the other of the profile and social graph density scores but not both if the social network 200 policies or empirical analysis indicates that the people affinity score should be focused on only one of the profile or social graph density scores.

As described herein, the type context score is based on the actual content item 306 that is the subject of the likelihood score in relation to the user 202A corresponding to the user interface 300 on which the content item 306 is being considered for display. The type context score is based on a content item type of the content item 306, as disclosed herein, in relation to activities 118 by the user 202A in relation to other content items 306 of the same type. In particular, the type context score may be based on a propensity for the user 202A to engage with content items 306 of that same content item type.

In an example, activities 118 in which the user 202A did or did not interact with a different content item 306 of the same content item type as the subject content item 306 are assessed. In an example, the type context score is a percentage or rate at which the user 202A has interacted with content items 306 of the same type. Thus, in such an example, if the user 202A has interacted with content items 306 of the subject content item type twenty percent of the time, those content items 306 are displayed on the user interface 300, the type context score may be 0.20. The type context score may be over a predetermined timeframe, e.g., weeks, months or more, or over a complete activities 118 history of the user 202A.

Alternatively or additionally, a relative quality of the interactions of the activities 118 may be incorporated. In an example, the rate or percentage may be adjusted based on the types of interactions in the activities 118. Thus, in an example, if an activity 118 is a comment or a share, then the type context score may be left unadjusted. However, if the interaction is a “like”, then the type context score may be adjusted down, for instance by being multiplied by 0.98 or another factor that represents the relative value of a “like” to a comment or a share.

Further alternatively, the type context score may not be based on a rate or percentage but on a combination of values of individual interactions. Thus, in an example, a comment may be worth 1.0, a share may be worth 0.8, clicking on a link may be worth 0.6, a “like” may be worth 0.3, and so forth. Each of the interactions related to the content item type may be combined according to a mathematical or statistical operation as disclosed herein. In an example, the values are added to one another to obtain the type context score.

In various examples, the type context score may additionally or alternatively be based on a mathematical model that may compensate for additional factors related to the past interactions with the content items 306 of the content item type. Such additional factors may include a position 304 of other content items 306 of the content item type in the feed 302, a time since the other content item 306 were posted in the feed 302, and so forth, as well as potentially relatively more refined or relevant relationships between the factors that account for the content item type.

In an example, a Gamma-Poisson model incorporates each element of the content item type (e.g., actor, source, verb, etc.) as well as the additional factors that may be incorporated. The Gamma-Poisson model incorporates a number of interactions from the activities 118 with content items 306 of the same content item type divided by a total number of times the content items 306 of the content item type were displayed, e.g., the rate at which the content item type was interacted with, as disclosed herein.

Application of the Poisson function may be based on (e.g., adjusted by) a value of each additional factor, as disclosed herein. The value of a position 304 may be inversely proportional to the rank of the position 304, i.e., the “value” of an interaction with a content item 306 may be higher if the content item 306 was in a lower position 304 (e.g., the fifth position 304(5)) than a higher position (e.g., the first position 304(1)). Thus, the fifth position 304(5) may have a value of 0.8 while the first position 304(1) may have a value of 0.2. Relatedly, the values of the various types of interactions disclosed above may also be applied.

A Poisson distribution is based on a number of interactions with content items 306. Based on the Poisson distribution, a response bias offset corresponding, for instance, to a maximum of a probability density function of the additional factors. The response bias offset may be multiplied by the rate at which the content item type has been interacted with to determine the type context score.

Stated differently, denoting by pe actual interactions with various content items 306 for activity impression e with covariates xe accounting for the additional factors, as disclosed herein, the following relationship may be determined:

pₑ=bₑαᵢₖ,

In such an example, be is a probability estimate computed from a baseline model which is a function of covariates xe, and αik is modeled as an interactions correction factor which is a function of a viewer and content item 306 type pair (i, k) and does not depend on covariates xe. Logistic regression may also be applied as follows:

$${p}_{e} = \frac{1}{1 + {e}^{- {θ}^{T} {X}_{e}}} \cdot {α}_{ik} .$$

The covariates xe include features that can remove position bias, profile viewers, and profile activities. The features are not necessarily bound to the member and activity type pair. The expected number of interactions may be determined as:

$${E}_{ik} = {\sum }_{e ∈ i , k} {b}_{e}$$

In various examples, Sᵢₖ|Eᵢₖ,αᵢₖ follows Gamma-Poission distribution Sᵢₖ|Eᵢₖ,αᵢₖ˜Poisson (Sᵢₖαᵢₖ),αᵢₖ˜Gamma(1,γ). As the correction factor, the value of αik depends on the O/E (observed-to-expected) ratio Sik/Eik: if Sik/Eik>1. In various examples, there may be an under-estimation of the number of interactions, so αik>1 may force an expected number of interactions equal to a number of observed interactions. In circumstances where Sik/Eik=1, αik=1, correction may be unnecessary. In circumstances where Sik/Eik<1, αik<1 may over-estimate the number of interactions. According to the Gamma-Poisson conjugate property, the posterior of αik also follows the Gamma distribution with mean

$$\frac{γ + {S}_{ik}}{γ + {E}_{ik}}$$

and variance

$$\frac{γ + {S}_{ik}}{{( γ + {E}_{ik} )}^{2}} .$$

In various examples, αik as the posterior mean of Gamma distribution:

$${\hat{α}}_{ik} = \frac{γ + {S}_{ik}}{γ + {E}_{ik}} = \frac{γ + {S}_{ik}}{γ + {\sum }_{e ∈ i , k} \frac{1}{1 + {e}^{- {θ}^{T} {X}_{e}}}} .$$

The interactions estimate for activity impression e with covariates xe provides the score \hat{p}ₑ:

$${\hat{p}}_{e} = \frac{{\hat{α}}_{ik}}{1 + {e}^{- {θ}^{T} {X}_{e}}} .$$

The score \hat{p}ₑ reflects any of a variety of scores that may reflect a relationship between two or more factors obtainable from the social network, including the people affinity score and the type context score. The score may also reflect the people affinity in type context score, which may be a tuple of the member and the actor in the context of a content item of a particular type, and so forth. The likelihood score may then be determined by applying the type context score to the people affinity score and any other score that may have been determined. The combination of the people affinity and type context scores, among the various additional optional scores, may be based on any of the mathematical or statistical operations disclosed herein. In an example, the people affinity and type context scores are added together to obtain the likelihood score.

The determination of the likelihood score described above is with respect to one content item 306 that is being considered for display on the user interface 300 associated with the user 202A. It is to be understood that in order to populate the feed 302, however, a group of content items 306 may be separately assessed for likelihood scores and ranked with respect to one another according to the likelihood. The social network system 100 may utilize those likelihood scores and other factors to order the content items 306 and cause those content items 306 to be displayed in appropriate positions.

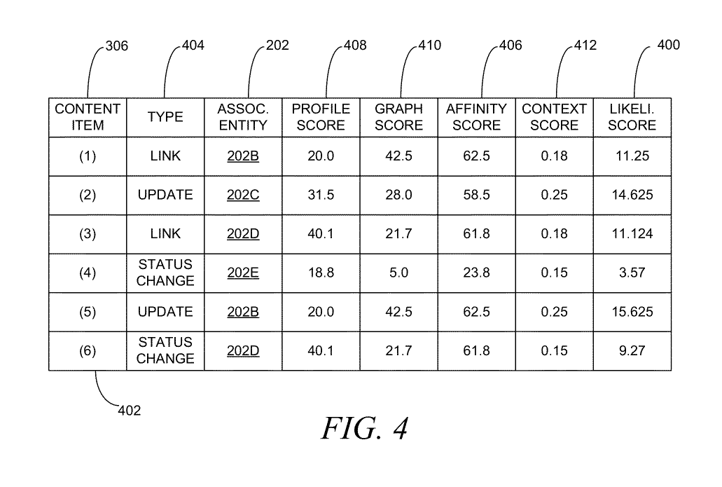

FIG. 4 illustrates the determination of likelihood scores 400 for multiple content items 306 of a group 402 of content items 306 that is being considered for display on a user interface 300, in an example embodiment. The likelihood scores 400 are determined according to the principles disclosed herein and the particular methodology detailed is for illustrative example and is non-limiting. Continuing the above examples, the content items 306 are being considered for display on the user interface 300 corresponding to the member 202A.

Each content item 306 includes a content item type 404 and an associated user 202. As disclosed herein, the associated user 202 may either be an originator of the content item 306 or may be a subject of the content item 306. For each content item 306 of the group 402 of content items 306, a people affinity score 406 is determined between the member 202A and the associated user 202. The people affinity score 406 is determined by summing a profile score 408 and a social graph density score 410. The individual profile scores 408 and social graph density scores 410 may be determined according to the methods disclosed herein. It is noted that for content items 306 that have the same associated user 202, the profile score 408, social graph density score 410, and resultant affinity score 406 is inherently the same as the people affinity score 406 is agnostic to the associated content item 306. Therefore, the people affinity score 406 would only need to be computed once for each associated user 202 in the group 402 of content items 306.

The type context score 412 is determined based on the content item type 404 for each content item 306 according to the methods disclosed herein. As disclosed herein, the type context score 412 is based on the activities 118 of the member 202A and the content item type 404 of the individual content items 306. Thus, to the extent that more than one content item 306 has the same content item type 404 the type context scores 412 of those content items 306 would be the same.

The likelihood score 400 for each of the content items 306 is then determined by multiplying the people affinity score 406 by the type context score 412. In an example, the content items 306 may be ranked according to their respective likelihood scores 400. In a simplified example, the content items 306 may then be displayed on the feed 302 in positions 304 corresponding to their rank, with the highest ranked content item 306 in the first position 304(1), the second highest ranked content item 306 in the second position 304(2), and so forth until the positions 304 are filled. More expansively, the social network system 100 may incorporate the likelihood score 400 for each content item 306 with other factors related to the content item 306. For instance, a sponsored content bid, determined non-monetary values, and content diversity requirements may be incorporated to select the final positions 304 for the content items 306. Such subject matter is disclosed, for instance, in U.S. application Ser. No. 14/633,382, “SOCIAL NETWORK CONTENT ITEM FEDERATION BASED ON ITEM UTILITY VALUE”, which is incorporated by reference herein in its entirety.

### Flowchart

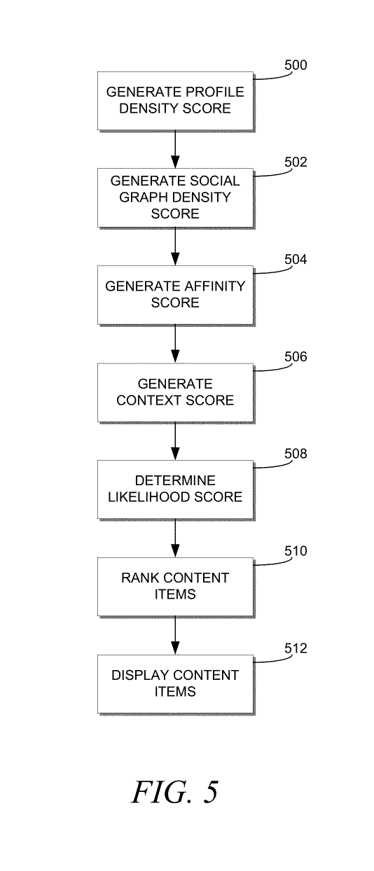

FIG. 5 is a flowchart for content provision based on user-affinity in a social network, in an example embodiment. The operations of the flowchart may be implemented on the social network system 100 or any suitable equipment or system.

At operation 500, a profile data score is generated with a processor based on related profile data between a member and a user. In an example, the profile data includes profile data points associated with the member and profile data points associated with the user, and wherein generating the profile score includes combining profile data values associated with related profile data points between the member and the user.

At operation 502, a social graph density score is generated based on social graph data. In an example, the social network includes a plurality of users including the user and the member, wherein ones of the plurality of users are connected to other ones of the plurality of users via connections in the social network, and wherein generating the social graph density score is based on values of connections within the social graph related to the member and the user.

At operation 504, a people affinity score is generated with the processor between a member of a social network and a user that is the subject of a content item of the social network. In an example, the people affinity score is based, at least in part, on the profile score. In an example, the people affinity score is based, at least in part, on the social graph density score.

At operation 506, a type context score is generated with a processor based, at least in part, on a content item type of the content item in relation to activity data related to the member and obtained from a database. In an example, the activity data includes past interactions by the member with content items of the content item type and wherein generating the type context score is based, at least in part, the interactions with the content items of the content item type. In an example, the type context score is based on a rate at which the member interacted with the content items of the content item type. In an example, the type context score is based on a quality of interactions with the content items of the content item type.

At operation 508, a likelihood score of the member interacting with the content item is determined by applying the type context score to the people affinity score. In an example, a plurality of likelihood scores are separately determined, individual ones of the plurality of likelihood scores having a corresponding one of a plurality of content items based on a people affinity score between the member and the one of the plurality of users as a subject of one of the plurality of content items and a type context score between the member and the subject one of the plurality of content items.

At operation 510, the plurality of content items are ranked based, at least in part, on the plurality of likelihood scores.

At operation 512, a user interface associated with the member is caused, with the processor, via a network interface, to display the content item based, at least in part, on the likelihood score.

### System

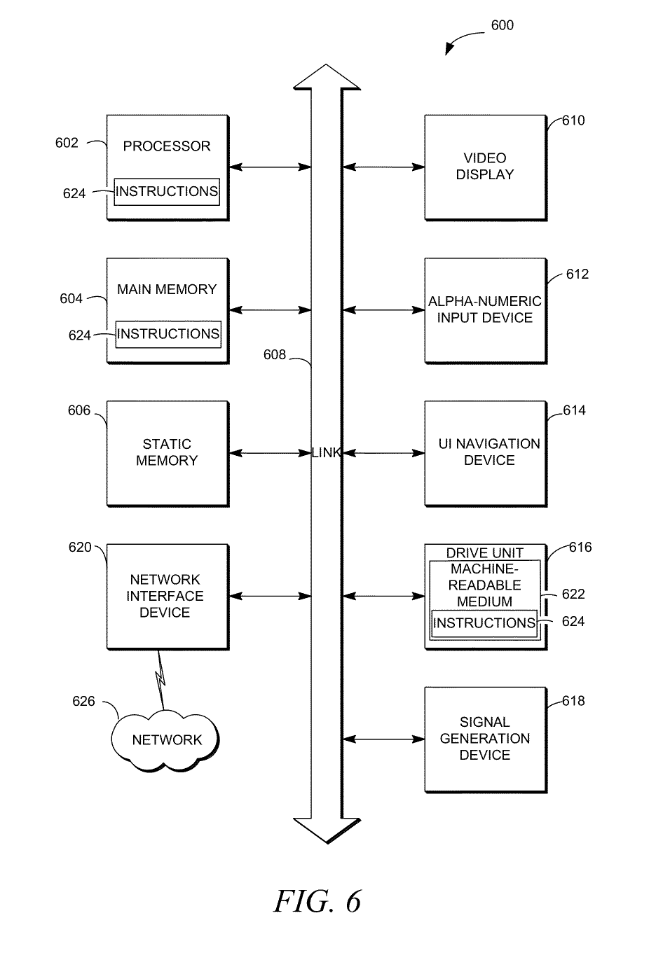

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, the machine 600 may implement the social network system 100 and the features included and described therein. The machine 600 thus describes specific hardware configurations on which the social network system 100 may be implemented and provided to users of the social network system 100.

FIG. 6 shows a diagrammatic representation of the machine 600 in the example form of a computer system and within which instructions 624 (e.g., software) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method, comprising:
generating, with a processor, a numerical profile data score based on profile data related to a member of a social networking service and a user, the user related to a content item having a content item type and hosted by the social networking service, the profile data stored in a database, wherein the profile data includes profile data points associated with the member and profile data points associated with the user, and wherein generating the profile data score includes combining numerical profile data values associated with profile data points associated with both the member and the user;
generating, with a processor, a people affinity score representing a measure of affinity between the member and the user, wherein generating the people affinity score is based on the profile data score and social graph data related to the member and the user, the social graph data stored in the database;
generating, with the processor, a type context score based, at least in part, on activities by the member, obtained from an activity database, with content items of the content item type previously hosted by the social networking service;
determining, with the processor, a likelihood score, representing a likelihood of the member interacting with the content item, by applying a mathematical operation to the type context score and the people affinity score; and
causing, via a network interface, a user interface associated with the member to display the content item based, at least in part, on the likelihood score.

2-4. (canceled)

5. The method of claim 1, further comprising generating, with the processor, a social graph density score based on the social graph data, and wherein generating the people affinity score is based, at least in part, on the social graph density score.

6. The method of claim 5, wherein the social networking system includes a plurality of users including the user and the member, wherein ones of the plurality of users are connected to other ones of the plurality of users via connections in the social network, and wherein generating the social graph density score is based on values of connections within the social graph related to the member and the user.

7. The method of claim 1, wherein the activity data includes past interactions by the member with content items of the content item type and wherein generating the type context score is based, at least in part, the interactions with the content items of the content item type.

8. The method of claim 7, wherein generating the type context score is based on a rate at which the member interacted with the content items of the content item type.

9. The method of claim 7, wherein generating the type context score is based on a quality of interactions with the content items of the content item type.

10. The method of claim 1, wherein the social networking system includes a plurality of users and a plurality of content items including the content item, wherein each content item has a content item type, and wherein each one of the plurality of content items has as a subject one of the plurality of users, and further comprising:
separately determining a plurality of likelihood scores, individual ones of the plurality of likelihood scores having a corresponding one of the plurality of content items based on a people affinity score between the member and the one of the plurality of users as a subject of one of the plurality of content items and a type context score between the member and the subject one of the plurality of content items;
ranking, with the processor, the plurality of content items based, at least in part, on the plurality of likelihood scores; and
wherein causing the user interface to display the content item includes displaying at least some of the plurality of content items according to the ranking.

11. A system, comprising:
a computer readable medium comprising instructions which, when implemented by a processor, cause the processor to perform operations comprising:
generate a numerical profile data score based on profile data related to a member of a social networking service and a user, the user related to a content item having a content item type and hosted by the social networking service, the profile data stored in a database, wherein the profile data includes profile data points associated with the member and profile data points associated with the user, and wherein generating the profile data score includes combining numerical profile data values associated with profile data points associated with both the member and the user;
generate a people affinity score representing a measure of affinity between the member and the user, wherein generating the people affinity score is based on the profile data score and social graph data related to the member and the user, the social graph data stored in the database;
generate a type context score based, at least in part, on activities by the member, obtained from an activity database, with content items of the content item type previously hosted by the social networking service;
determine a likelihood score, representing a likelihood of the member interacting with the content item, by applying a mathematical operation to the type context score and the people affinity score; and
cause a user interface associated with the member to display the content item based, at least in part, on the likelihood score.

12-14. (canceled)

15. The system of claim 11, wherein the instructions further cause the processor to generate a social graph density score based on the social graph data, and wherein generating the people affinity score is based, at least in part, on the social graph density score.

16. The system of claim 15, wherein the social networking system includes a plurality of users including the user and the member, wherein ones of the plurality of users are connected to other ones of the plurality of users via connections in the social networking service, and wherein instructions further cause the processor to generate the social graph density score based on values of connections within the social graph related to the member and the user.

17. The system of claim 11, wherein the activity data includes past interactions by the member with content items of the content item type and wherein the instructions further cause the processor to generate the type context score based, at least in part, the interactions with the content items of the content item type.

18. The system of claim 17, wherein the instructions further cause the processor to generate the type context score based on a rate at which the member interacted with the content items of the content item type.

19. The system of claim 17, wherein the instructions further cause the processor to generate the type context score based on a quality of interactions with the content items of the content item type.

20. (canceled)

21. A computer readable medium comprising instructions which, when implemented by a processor, cause the processor to perform operations comprising:
generate a numerical profile data score based on profile data related to a member of a social networking service and a user, the user related to a content item having a content item type and hosted by the social networking service, the profile data stored in a database, wherein the profile data includes profile data points associated with the member and profile data points associated with the user, and wherein generating the profile data score includes combining numerical profile data values associated with profile data points associated with both the member and the user;
generate a people affinity score representing a measure of affinity, the member and the user, wherein generating the people affinity score is based on the profile data score and social graph data related to the member and the user, the social graph data stored in the database,
generate a type context score based, at least in part, on activities by the member, obtained from an activity database, with content items of the content item type previously hosted by the social networking service;
determine a likelihood score, representing a likelihood of the member interacting with the content item, by applying a mathematical operation to the type context score and the people affinity score; and
cause a user interface associated with the member to display the content item based, at least in part, on the likelihood score.

22. The computer readable medium of claim 21, wherein the instructions further cause the processor to generate a social graph density score based on the social graph data, and wherein generating the people affinity score is based, at least in part, on the social graph density score.

23. The computer readable medium of claim 22, wherein the social networking system includes a plurality of users including the user and the member, wherein ones of the plurality of users are connected to other ones of the plurality of users via connections in the social networking service, and wherein instructions further cause the processor to generate the social graph density score based on values of connections within the social graph related to the member and the user.

24. The computer readable medium of claim 21, wherein the activity data includes past interactions by the member with content items of the content item type and wherein the instructions further cause the processor to generate the type context score based, at least in part, the interactions with the content items of the content item type.

25. The computer readable medium of claim 24, wherein the instructions further cause the processor to generate the type context score based on a rate at which the member interacted with the content items of the content item type.

26. The computer readable medium of claim 24, wherein the instructions further cause the processor to generate the type context score based on a quality of interactions with the content items of the content item type.

27. The computer readable medium of claim 21, wherein the social networking system includes a plurality of users and a plurality of content items including the content item, wherein each content item has a content item type, and wherein each one of the plurality of content items has as a subject one of the plurality of users, and further comprising:
separately determining a plurality of likelihood scores, individual ones of the plurality of likelihood scores having a corresponding one of the plurality of content items based on a people affinity score between the member and the one of the plurality of users as a subject of one of the plurality of content items and a type context score between the member and the subject one of the plurality of content items;
ranking, with the processor, the plurality of content items based, at least in part, on the plurality of likelihood scores; and
wherein causing the user interface to display the content item includes displaying at least some of the plurality of content items according to the ranking.
